(19) United States
(12) Patent Application Publication
(10) Pub. No.: US 2026/0326701 A1
(43) Pub. Date: Oct. 22, 2026

(54) Apparatus and Method for Controlling a Child Safety Lock of a Vehicle

(71) Applicant: Bayerische Motoren Werke Aktiengesellschaft, Muenchen (DE)

(72) Inventors: Johannes Feldmaier, Ebersberg (DE); Simone Camberg, Muenchen (DE); Thomas Ewender, Bad Aibling (DE)

(21) Appl. No.: 19/122,816

(22) PCT Filed: Jul. 5, 2023
(86) PCT No.: PCT/EP2023/068479

§ 371 Date: Apr. 21, 2025

(30) Foreign Application Priority Data
Oct. 25, 2022 (DE) 10 2022 128 276.7

(51) Int. Cl. B60R 21/015; B60R 25/01; G06V 20/59; G06V 40/16; G06V 40/20

(52) U.S. Cl. CPC B60R 21/01538; B60R 25/01; G06V 20/597; G06V 40/178; G06V 40/28

(57) ABSTRACT

An apparatus for controlling a child safety lock of a vehicle includes at least one image-generating system and a control unit. The image-generating system captures at least one image with a depiction of an area of the passenger compartment and generates image data corresponding to the image. The control unit processes the image data, to determine, based on the image data, whether an occupant intends to open the vehicle door, and determines on the basis of the image data whether the occupant of the vehicle is a child or an adult. The control unit blocks an opening of the door if the control unit has determined that the occupant intends to open the door of the vehicle and the occupant is a child, or allows the opening of the door if the occupant intends to open the door of the vehicle and is an adult.

The present application is the U.S. national phase of PCT Application PCT/EP2023/068479 filed on Jul. 5, 2023, which claims priority of German patent application No. 10 2022 128 276.7 filed on Oct. 25, 2022, the entire contents of which are incorporated herein by reference.

### TECHNICAL FIELD

The disclosure relates to the field of vehicles, and more particularly to devices and methods for controlling a child safety lock of a vehicle. The invention further relates to a method for controlling a child safety lock of a vehicle.

### BACKGROUND

Child safety locks for doors and windows of vehicles, especially passenger cars, are known from the prior art. Child safety locks prevent children in particular from opening doors or windows of vehicles, for example while driving.

Document EP 4 027 307 A1 discloses a device for the protection of children in a vehicle. The device is designed to classify occupants as children or adults. The device is also designed to activate a child safety lock on a door of the vehicle while driving if children are detected in the passenger compartment or if another vehicle is approaching the vehicle from behind.

Document US 2010/138113 A1 discloses another device for the protection of children in a vehicle. The device is designed to detect children inside the vehicle with the help of a camera. The device is also designed to block the door and window openers of the vehicle if children are detected inside the vehicle.

Document CN 108625709 A discloses a system for operating a window lifter of a vehicle. The system is designed to use a camera to detect whether a child is operating a window lifter. The system is also designed to prevent the window from being fully opened if it detects that a child is operating the window lifter.

Well-known child safety locks are often not user-friendly. Generally, child safety locks must be manually activated and deactivated by a vehicle driver. Even automated child safety locks completely block the opening of doors and windows when there are children in the passenger compartment. As a result, even adult vehicle occupants cannot open some doors and windows from the inside when children are in the passenger compartment.

On the basis of the known prior art, there is a need for a device and a method for controlling a child safety lock of a vehicle that are more user-friendly than previously known child safety locks.

### SUMMARY

The above-described need, as well as others, are met by one or more embodiments disclosed herein.

One embodiment includes a device for controlling a child safety lock of a vehicle contains at least one image-generating system of the vehicle. The image-generating system is designed to capture at least one image with a depiction of an area of the passenger compartment and to generate image data corresponding to the image. The device also contains a control unit that is designed to process the image data, to determine, on the basis of the image data, whether an occupant intends to open a door of the vehicle, to determine whether the occupant of the vehicle is a child or an adult on the basis of the image data, and to block the door from opening if the control unit has determined that the occupant who intends to open the door of the vehicle is a child. In an alternative embodiment, the control unit is designed to allow the door to be opened only if the control unit has determined that the occupant intending to open the door of the vehicle is an adult.

The device in some embodiments detects whether the occupant who is about to open the door of the vehicle is a child or an adult. To do this, the control unit first determines the occupant in the image of the passenger compartment captured by the image-generating system. The control unit then determines whether the occupant intends to open a door of the vehicle and whether the occupant is a child or an adult. If the device detects that a child is about to open the door, the device blocks the door from opening. In the alternative embodiment, the device only allows the door to be opened if the device has detected that an adult is about to open the door. In contrast to well-known child safety locks, however, the opening of the door is not permanently blocked, so that, for example, an adult occupant of the vehicle can open the door without having to switch off the child safety lock first. In particular, an adult occupant can open a door for the child without first deactivating the child safety lock. In other words, the device specifically blocks the opening of the door only when a child tries to open the door. Adult occupants are therefore not locked in by the child safety lock. This increases ease of use without compromising safety for the child.

In this document, an image-generating system is understood to mean any system that is designed to produce a two-dimensional or three-dimensional image. In particular, an image-generating system is understood to be a camera that captures a two-dimensional image. Alternatively, the camera can be a time-of-flight camera that captures a three-dimensional image. In particular, the camera detects light in the visual spectrum and/or in the infrared spectrum. Alternatively, the image-generating system can also be formed by a RADAR or LIDAR system that generates a three-dimensional image of the passenger compartment, especially in the form of a point cloud.

In some embodiments, the image-generating system is designed to capture several images in succession with the depiction of the area of the passenger compartment and to generate image data corresponding to the images. The control unit may be designed to detect the occupant's movement on the basis of the image data and to determine, on the basis of the detected movement, whether the occupant intends to open the door of the vehicle. In this embodiment, the image-generating system captures an image sequence or a video sequence. From this sequence, movements that the occupant performs with his hand, for example, can be better recognized. To be able to open the door, the occupant must perform a certain movement. For example, the occupant has to grab an operating mechanism for the door lock. Such a movement can be extracted from the sequence, for example using a suitable machine learning method. It is therefore possible to determine particularly reliably whether the occupant intends to open the door of the vehicle.

In some embodiments, the position of at least one of the door openers of the vehicle is stored in a memory area of the control unit. The control unit is designed to determine the position of at least one arm of the occupant and a hand position of the hand of the arm on the basis of the image data, and to determine that the occupant intends to open the door of the vehicle if the hand position corresponds to the position of the door opener. The determination of the position of the arm and the hand position can be done, for example, using a suitable machine learning method. The door opener is, for example, a door handle or a button that opens the door automatically. If the occupant moves his hand towards the door opener, it can be assumed from this that the occupant intends to open the door of the vehicle. In this embodiment, it can therefore be determined very reliably whether the occupant intends to open the door of the vehicle.

In some embodiments, the control unit is designed to determine the position of the arm and/or the hand position on the basis of the image data and using a human pose estimation method. The human pose estimation method reliably determines the position of the arm as a three-dimensional vector from the two-dimensional image of the image-generating system. In particular, the hand position can also be determined with the help of the human pose estimation method, even if it is not visible in the image. In the present case, the control unit can thus reliably determine whether the hand position corresponds to the position of the door opener even if the position of the door opener is not visible in the picture.

In at least some embodiments, the control unit is designed to detect whether the vehicle is in motion and to block the door from opening if the control unit has determined that the occupant is a child and that the vehicle is in motion. Especially when in motion, it would be particularly dangerous if a child were to open the door. The device in this embodiment is therefore designed to prevent the door from being opened by a child, especially when the vehicle is in motion. This means that children in the passenger compartment are even better protected by the device.

In some embodiments, the device contains a sensor of the vehicle that is designed to capture at least one image with a depiction of an area outside the vehicle and to generate sensor data corresponding to the image. The control unit is designed to process the sensor data and, on the basis of the sensor data, determine if another vehicle is approaching the vehicle and block the door opening if the control unit has determined that the occupant is a child and that another vehicle is approaching the vehicle. The sensor can be a camera. Alternatively, the sensor can also be a RADAR or LIDAR sensor. The sensor detects the vehicle surroundings. On the basis of the sensor data recorded by the sensor, the control unit then determines whether the other vehicle is approaching the vehicle. If a child in particular tries to leave the vehicle while the other vehicle is approaching, very dangerous situations can occur. For example, the driver of the other vehicle may have to brake abruptly to avoid the child. In the worst case, the child can be seriously injured. Because the device in this embodiment prevents a child from opening the door when another vehicle is approaching, the device protects the child even better.

In some cases, the control unit is designed to determine whether the occupant is a child on the basis of the image data and using a machine learning method. In particular, the machine learning method is an age classification method, such as a facial recognition method. Known age classification methods can reliably classify people as children and adults. Alternatively or additionally, the occupant's size can be determined with the help of the human pose estimation method. On the basis of the occupant's size, the occupant can then be classified as a child or adult. To make the classification of the occupant more reliable, additional features can be extracted from the image of the camera. For example, a suitable machine learning method can be used to determine whether the occupant is sitting in a child seat or similar, or it is possible to infer the age of the occupant from the clothing style. The use of a machine learning method makes the determination of whether the person who intends to open the door is a child particularly reliable.

In some implementations, the control unit is designed to determine, on the basis of the image data, whether the occupant intends to operate a window lifter of the vehicle, and to block the window lifter if the control unit has determined that the occupant is a child. With this embodiment, the device is also designed to prevent a child from operating a window lifter. This embodiment can be developed accordingly, in particular by means of all the features mentioned in this document that relate to the opening of the door.

The disclosure further relates to a method for controlling a child safety lock of a vehicle. With this method, at least one image with a depiction of an area of the passenger compartment is captured. Image data corresponding to the image are generated. On the basis of the image data, it is determined whether an occupant intends to open a door of the vehicle. On the basis of the image data, it is determined whether the occupant of the vehicle is a child or an adult. Furthermore, the opening of the door is blocked if it has been determined that the occupant who intends to open the door of the vehicle is a child.

The method has many of the same advantages as the device described above. In particular, the method may be developed with the features of the dependent claims directed towards the device.

The above-described features and advantages, as well as

others, will become more readily apparent to those of ordinary skill in the art by reference to the following detailed description and accompanying drawings.

### BRIEF DESCRIPTION OF THE DRAWINGS

FIG. 1 shows a perspective schematic representation of a cockpit of a vehicle;

FIG. 2 shows in a schematic representation an image of the passenger compartment of the vehicle taken by a camera; and

FIG. 3 shows the schedule of the method for controlling the child safety lock of the vehicle.

### DETAILED DESCRIPTION

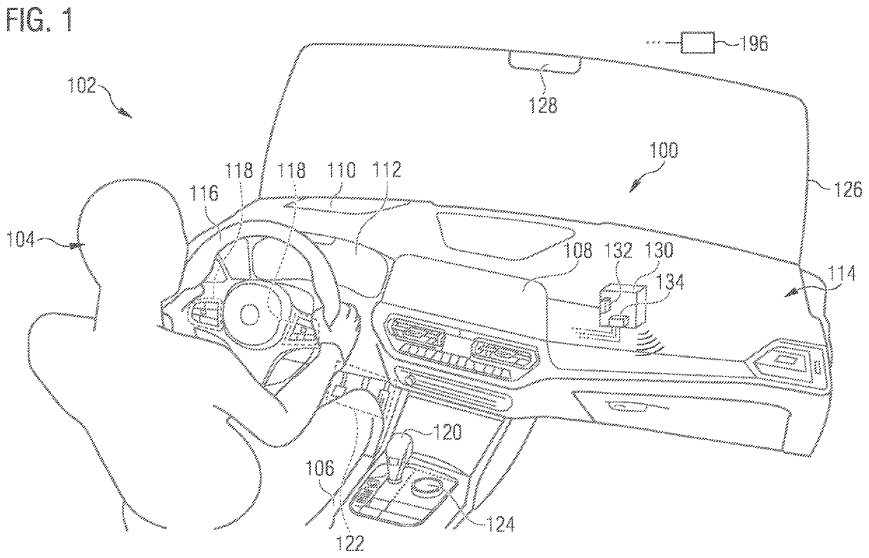

FIG. 1 shows a perspective schematic representation of a cockpit 100 of a vehicle 102.

A vehicle driver 104 sits on a driver's seat 106 of the vehicle 102. The cockpit 100 contains a central information display 108 (CID), a head up display 110 and a graphic instrument cluster 112, which are arranged on a dashboard 114 of the vehicle 102. The cockpit 100 also contains a steering wheel 116 with control elements 118, a gear selector 120, a pedal set 122 and an input unit 124 with a rotary wheel and a push-button function and/or a touch sensitive input field. This input unit 124 is also known as the Ergo Commander.

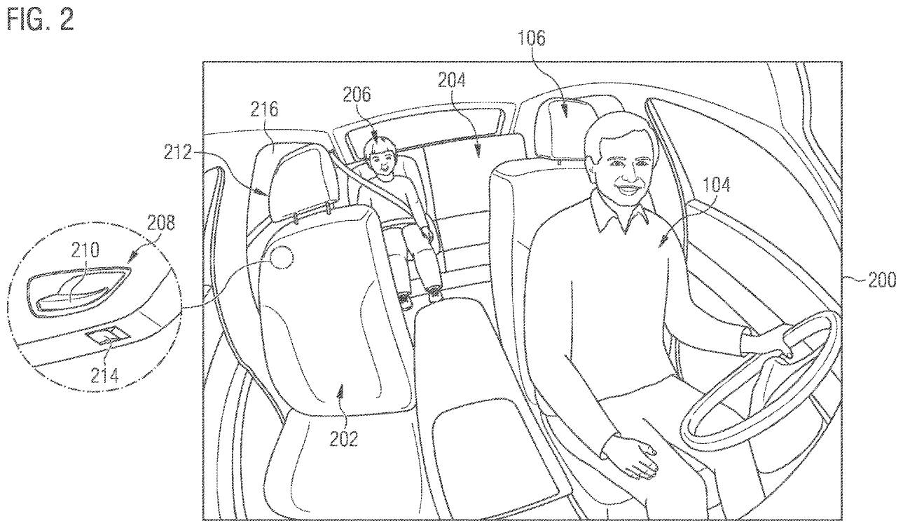

In the upper part of a windshield 126 of the vehicle 102, a camera 128 is arranged as an image-generating system. The camera 128 is arranged and oriented in such a way that the camera 128 can capture images with a depiction of an area of the interior of the vehicle 102. An exemplary image 200 of the camera 128 is described below on the basis of FIG. 2. In particular, the camera 128 is designed to capture several images in succession, to generate image data corresponding to the images and to transmit these to a control unit 130.

The control unit 130 has data outputs 132 and data inputs 134, which are used to connect with other units of the vehicle 102, such as other sensors, input and output units, and control units of assistance systems. In particular, the control unit 130 is connected to a sensor 136 which is designed to capture at least one image with a depiction of an area outside the vehicle 102, to generate sensor data corresponding to the image and to transmit this sensor data to the control unit 130. Specifically, the sensor 136 is a RADAR or LIDAR sensor or another camera. On the basis of the sensor data, the control unit 130 can determine in particular whether another vehicle is approaching the vehicle 102.

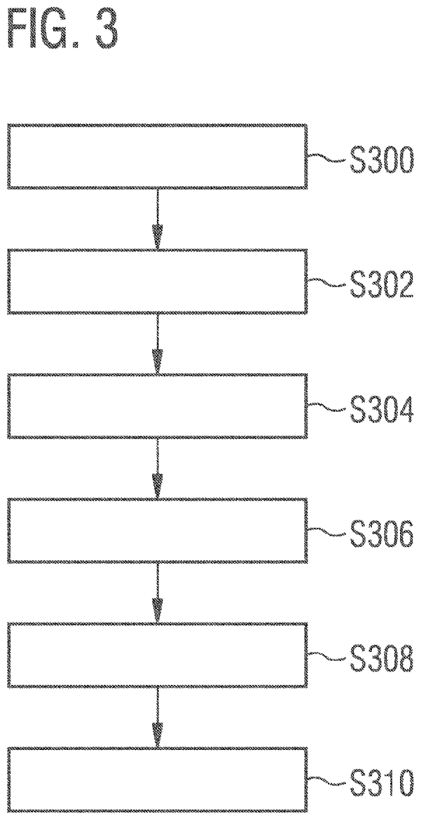

The control unit 130 is designed to carry out a method for controlling a child safety lock on the vehicle 102. In the method, the camera 128 is used to determine whether a child or an adult intends to open a door of the vehicle 102 or to operate a window lifter of the vehicle 102. If it has been determined that the child intends to open a door or operate a window lifter, the control unit 130 blocks the opening of the door or window. Alternatively, the control unit 130 is designed to allow the door to be opened only when an adult opens the door. The process is described in more detail below using FIGS. 2 and 3.

FIG. 2 shows a schematic representation of an image 200 of the interior of the vehicle 102 taken by the camera 128.

The camera 128 has a field of view of 120 degrees. In other embodiments, the camera 128 can also have a field of view in the region of 150 degrees or more. The camera 128 is oriented towards the driver's seat 106, a passenger seat 202 and a rear seat 204 of the vehicle 102. In the situation shown in FIG. 2, a child 206 is sitting on the rear seat 204 of the vehicle 102. In addition to the child 206, the vehicle driver 104 is also present in the vehicle interior, sitting on the driver's seat 106 of the vehicle 102.

A detail drawing in FIG. 2 shows an area 208 around a door handle 210 of a door 212 in the rear area of the vehicle 102 on the side on which the child 206 is sitting. In addition to the door handle 210, which forms a door opener, the area includes a control element 214 for a window lifter of a window of the door 212. The area 208 around the door handle 210 is concealed in the image of the camera 128 by a passenger seat 202 of the vehicle 102. The position of the door handle 210 and of the control element 214 of the window lifter are stored in a memory area of the control unit 130.

In order to determine whether one of the occupants intends to open the door 212, the control unit 130 first determines a hand position of the occupant from the image data. In order to be able to determine the hand position in vehicle-specific coordinates, the control unit 130 is specially designed to determine fixed reference points, such as door handles, buttons or switches, in the passenger compartment on the basis of the image data. The determination of the reference points can be carried out in particular by using CAD images of the passenger compartment.

In order to determine the hand position, the control unit 130 carries out a human pose estimation method in particular. The human pose estimation method has the advantage that the hand position of the occupant can be determined even if, as in the situation shown in FIG. 2, the hand is not visible in the image 200 of the camera 128 because, for example, it is concealed by the passenger seat 202 or the driver's seat 106. If the hand position of the occupant matches one of the positions of a door opener stored in the memory area of the control unit 130, the control unit 130 determines that the occupant is trying to open the door 212.

The control unit 130 then determines whether the occupant who wishes to open door 212 is the child 206 or an adult. For this purpose, the control unit 130 carries out a facial recognition method or other suitable machine learning method. If the control unit 130 detects that the child 206 is currently trying to open the door 212, the control unit 130 blocks the opening of the door 212. In particular, the control unit blocks the opening of the door 212 if the vehicle 102 is moving or if the control unit has determined on the basis of the sensor data of the sensor 136 that another vehicle 102 is approaching the vehicle 102. Alternatively, the control unit 130 only allows the opening of the door 212 when an adult opens the door 212.

In a similar way, the control unit 130 can also prevent the child 206 from operating a window lifter of the vehicle 102 to open a window 216. For this purpose, the control unit 130 determines whether the determined hand position of the child 206 matches the positions of the control element 214 of the window lifter stored in the memory area of the control unit 130. If the hand position of the child 206 matches the positions of the control element 214 of the window lifter, the control unit 130 determines that the child 206 is trying to operate the window lifter. In particular, the control unit 130 can then block the opening of the window 216 with the help of the window lifter.

FIG. 3 shows the schedule of the method for controlling the child safety lock of the vehicle 102.

In step S300, the method is started. In step $302, the control unit 130 controls the camera 128 in such a way that the camera 128 captures at least one image 200 with a depiction of the passenger compartment. The image data corresponding to the image 200 are generated by the camera 128 and transmitted to the control unit 130. In step S304, the control unit 130 determines on the basis of the image data whether one of the occupants of the vehicle 102 intends to open one of the doors of the vehicle 102 or to operate one of the window lifters. In step S306, the control unit 130 then determines on the basis of the image data whether the occupant who is about to open one of the doors of the vehicle 102 or operate one of the window lifters is a child or an adult. If the control unit 130 determines that the occupant is a child, in step S308 the control unit 130 blocks the opening of the door or window in order to protect the child. Alternatively, in step $308 the control unit only allows the opening of the door or window if the control unit 130 has determined that an adult wants to open the door or window. In step S310 the method is ended.

In the exemplary embodiment described in FIGS. 1 to 3, the camera 128 and the control unit 130 form a device for controlling a child safety lock of the vehicle 102. Other elements and features shown in FIGS. 1 to 3 and mentioned in the preceding description may be part of this device.

### REFERENCE SIGN LIST

100 Cockpit
102 Vehicle
104 Vehicle driver
106 Driver's seat
108,110,112 Display element
114 Dashboard
116 Steering wheel
118 Control element
120 Gear selector
122 Pedal set
124 Input unit
126 Windscreen
128 Camera
130 Control unit
132 Data output
134 Data input
136 Sensor
200 Image
202 Passenger seat
204 Bench seat
206 Child
208 Area
210 Door handle
212 Door

1.-9. (canceled)

10. An apparatus for controlling a child safety lock of a vehicle having a passenger compartment, comprising:
at least one image-generating system of the vehicle that is configured to capture at least one image with a depiction of an area of the passenger compartment and to generate image data corresponding to the at least one image; and
a control unit that is configured to process the image data, to determine, on the basis of the image data, whether an occupant intends to open a door of the vehicle, to determine on the basis of the image data whether the occupant of the vehicle is a child or an adult, and to block an opening of the door if the control unit has determined that the occupant intends to open the door of the vehicle and the occupant is a child, or to allow the opening of the door if the control unit has determined that the occupant intends to open the door of the vehicle and is an adult.

11. The apparatus as claimed in claim 10, wherein:
the image-generating system is configured to capture the at least one image as a plurality of images in succession in time with the depiction of the area of the passenger compartment and to generate the image data corresponding to the plurality of images; and
the control unit is configured to detect a movement of the occupant on the basis of the image data and to determine, on the basis of the detected movement, whether the occupant intends to open the door of the vehicle.

12. The apparatus as claimed in claim 11, wherein the control unit is configured to determine whether the vehicle is in motion and to block the opening of the door if the control unit has determined that the occupant is a child and that the vehicle is in motion.

13. The apparatus as claimed in claim 11, wherein:
the position of at least a first door opener of the vehicle is stored in a memory area of the control unit; and
the control unit is configured to determine, on the basis of the image data, a position of at least a first arm of the occupant and a hand position of a hand of the first arm, and to determine that the occupant intends to open the door of the vehicle if the hand position corresponds to the position of the first door opener.

14. The apparatus as claimed in claim 10, wherein:
the position of at least a first door opener of the vehicle is stored in a memory area of the control unit; and
the control unit is configured to determine, on the basis of the image data, a position of at least a first arm of the occupant and a hand position of a hand of the first arm, and to determine that the occupant intends to open the door of the vehicle if the hand position corresponds to the position of the first door opener.

15. The apparatus as claimed in claim 14, wherein the control unit is configured to determine the position of the first arm and using a human pose estimation method.

16. The apparatus as claimed in claim 14, wherein the control unit is configured to determine the hand position on the basis of the image data and using a human pose estimation method.

17. The apparatus as claimed in claim 16, wherein the control unit is configured to determine whether the occupant is a child on the basis of the image data and using a machine learning method.

18. The apparatus as claimed in claim 10, wherein the control unit is configured to determine whether the vehicle is in motion and to block the opening of the door if the control unit has determined that the occupant is a child and that the vehicle is in motion.

19. The apparatus as claimed in claim 18, further comprising a sensor of the vehicle that is configured to capture at least one outside image containing a depiction of an area outside the vehicle and to generate sensor data corresponding to the at least one outside image; and
wherein the control unit is configured to process the sensor data and to determine, on the basis of the sensor data, whether another vehicle is approaching the vehicle and to block the opening of the door if the control unit has determined that the occupant is a child and that another vehicle is approaching the vehicle.

20. The apparatus as claimed in claim 10, further comprising a sensor of the vehicle that is configured to capture at least one outside image containing a depiction of an area outside the vehicle and to generate sensor data corresponding to the at least one outside image; and
wherein the control unit is configured to process the sensor data and to determine, on the basis of the sensor data, whether another vehicle is approaching the vehicle and to block the opening of the door if the control unit has determined that the occupant is a child and that another vehicle is approaching the vehicle.

21. The apparatus as claimed in claim 10, wherein the control unit is configured to determine whether the occupant is a child on the basis of the image data and using a machine learning method.

22. The apparatus as claimed in claim 10, wherein the control unit is configured to determine, on the basis of the image data, whether the occupant intends to operate a window lifter of the vehicle, and to block the window lifter if the control unit has determined that the occupant is a child.

23. A method for controlling a child safety lock of a vehicle, comprising:
capturing at least one image with a depiction of an area of the passenger compartment;
generating image data corresponding to the at least one image;
determining, on the basis of the image data, whether an occupant intends to open a door of the vehicle;
determining, on the basis of the image data, whether the occupant of the vehicle is a child or an adult; and
blocking the opening of the door if it has been determined that the occupant intends to open the door of the vehicle and is a child.
